(19) United States
(12) Patent Application Publication
(10) Pub. No.: US 2006/0106744 A1
(43) Pub. Date: May 18, 2006

(54) Apparatus and method for establishing knowledge database used in expert system and recording medium therefor

(75) Inventors: Youn-ho Kim, Hwaseong-si (KR); Ji-yun Byun, Busan-si (KR); Yeun-bae Kim, Seongnam-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/280,210

(22) Filed: Nov. 17, 2005

(30) Foreign Application Priority Data
Nov. 17, 2004 (KR) 10-2004-0094265

(51) Int. Cl. G06N 5/02

(52) U.S. Cl. 706/46

(57) ABSTRACT

A method and apparatus for establishing a knowledge database used in an expert system, which can automatically establish a knowledge database without the aid of knowledge engineers, and a recording medium therefor are provided. The method includes: building up a hypothesis suitable for dealing with an assigned task; generating keywords used for searching a plurality of databases based on the hypothesis; collecting data from the databases through searching with reference to the keywords; and extracting knowledge for dealing with the assigned task from the collected data and systematizing the extracted knowledge to be storable in a knowledge database. The method of establishing a knowledge database can reduce the time and cost required for establishing a knowledge database system by automatically updating, maintaining, or fixing the knowledge database without the aid of knowledge engineers.

### BACKGROUND OF THE INVENTION

This application claims priority under 35 U.S.C. § 119 from Korean Patent Application No. 10-2004-0094265, filed on Nov. 17, 2004, in the Korean Intellectual Property Office, the disclosure of which is incorporated herein in its entirety by reference.

1. Field of the Invention

The present invention relates to a method and apparatus for establishing a knowledge database used in an expert system, and more particularly, to a method and apparatus for establishing a knowledge database used in an expert system, which can automatically establish the knowledge database without the aid of knowledge engineers, and a recording medium therefor.

2. Description of the Related Art

Expert systems, which belong to a field of research related to artificial intelligence, are computer systems that have learning, problem-solving, and reasoning capabilities, and thus can automatically deal with various tasks instead of using human experts, as shown in FIG. 1. In other words, expert systems are computer systems that can serve as experts providing expertise regarding specific fields. Expert systems have been disclosed in Japanese Patent Publication Nos. 1997-274569 (published on Oct. 21, 1997) and 1999-143712 (published on May 28, 1999).

Conventionally, an expert system is established by knowledge engineers capturing and then arranging the expertise of experts. Here, knowledge engineers are those who analyze a specific field to which an expert system is to be applied, gather expertise concerning the specific field from experts and other sources, such as books and publications, arrange the gathered expertise, and design and realize an expert system capable of dealing with various tasks regarding the specific field.

FIG. 2 is a block diagram of a conventional method of establishing a knowledge database. Referring to FIG. 2, a knowledge engineer gathers information regarding a specific field from experts in the specific field through interviews, analyzes the gathered information, and establishes a knowledge database based on the analyzed information. Here, the knowledge database, which is an element of an expert system, is a database of information acquired by the experts through intellectual activities, experience, and facts and rules required for solving various problems that may arise in the specific field. When storing the information and the facts and rules in a database, an IF-THEN format is applied.

When the experts deliver their expertise to the knowledge engineers, the knowledge engineers program knowledge gathered from the experts, thereby establishing the knowledge database.

However, it takes the knowledge engineers a considerable amount of time and effort to gather information from the experts, analyze the gathered information, and establish the knowledge database based on the analyzed information. In addition, the knowledge engineers may not be able to gather all of the expertise of the experts and to pigeonhole the gathered expertise in a systemized and organized manner because even the experts cannot memorize and organize all of their knowledge. Moreover, the knowledge engineers who are an intermediate between the knowledge database and the experts are not experts in the specific field. Thus, the knowledge engineers may establish the knowledge database without a full understanding of the gathered expertise, thus making it highly possible that the knowledge database contains errors.

Accordingly, it is very difficult to establish an expert system because of omissions and errors in the knowledge database.

The experts may know nothing about an expert system established by the knowledge engineers through code-based programming, and thus cannot manage the knowledge database without the aid of the knowledge engineers. On the other hand, the knowledge engineers may know nothing about the specific field, and thus cannot manage the knowledge database without the aid of the experts.

Since the maintenance of the knowledge database requires the cooperation of the experts and the knowledge engineers, a knowledge acquisition bottleneck may occur in the process of adding new knowledge to the knowledge database or updating information stored in the knowledge database in accordance with developments in the specific field.

To avoid such a knowledge acquisition bottleneck, a knowledge database management method that enables experts to directly input their knowledge into a knowledge database has been suggested. However, problems that expert systems are expected to tackle are becoming more diversified and the amount of data that expert systems are supposed to process is on the increase. In addition, there are not many experts who can fully understand and precisely analyze new information arising in their fields of study on a day-to-day basis, and different experts often have different levels of understanding and analytical capabilities. Thus, it is very difficult to guarantee the reliability of knowledge acquired by experts through analysis.

### SUMMARY OF THE INVENTION

The present invention provides a method of establishing a knowledge database of an expert system, which can automatically update, maintain, or fix information stored in the knowledge database without the aid of knowledge engineers.

The present invention also provides an apparatus for establishing a knowledge database of an expert system, which can automatically update, maintain, or fix information stored in the knowledge database without the aid of knowledge engineers.

The present invention also provides a computer-readable recording medium storing a program for executing the method of establishing a knowledge database.

According to an aspect of the present invention, there is provided a method of establishing a knowledge database. The method includes: building up a hypothesis suitable for dealing with an assigned task; generating keywords used for searching a plurality of databases based on the hypothesis; collecting data from the databases through searching with reference to the keywords; and extracting knowledge for dealing with the assigned task from the collected data and systematizing the extracted knowledge to be storable in a knowledge database.

The method of establishing a knowledge database of an expert system can reduce the time and cost required for establishing a knowledge database by automatically updating, maintaining, and fixing the knowledge database.

In addition, the method of establishing a knowledge database can establish a knowledge database without the aid of knowledge engineers by determining keywords necessary for dealing with an assigned task, searching for data using the keywords, and extracting knowledge from the searched data.

Moreover, the method of establishing a knowledge database can prevent overemphasis on data searched for using keywords, and thus can guarantee the reliability of a knowledge database by establishing the knowledge database using meaningful patterns extracted from a plurality of databases using a data mining method.

According to another aspect of the present invention, there is provided an apparatus for establishing a knowledge database. The apparatus includes: a hypothesis generation agent, which builds up a hypothesis suitable for dealing with an assigned task; a keyword generation agent, which generates keywords used for searching a plurality of databases based on the hypothesis; a search agent, which collects data from the databases through searching with reference to the keywords; a data mining agent, which extracts meaningful patterns from the collected data using a data mining method by filtering and analyzing the collected data and interpreting the analysis results; a knowledge systematization agent, which extracts knowledge for dealing with the assigned task from the collected data using the extracted meaningful patterns and systematizes the extracted knowledge to be storable in a knowledge database; and a knowledge acquisition control agent, which controls the operations of the hypothesis generation agent, the keyword generation agent, the search agent, the data mining agent, and the knowledge systematization agent when they deal with knowledge acquisition-related tasks.

The apparatus for establishing a knowledge database can extract knowledge from stores of information and efficiently establish a knowledge database based on the extracted knowledge without the aid of knowledge engineers or experts by automatically collecting data from a plurality of databases, filtering and analyzing the collected data, and interpreting the analysis results using a plurality of agents.

According to another aspect of the present invention, there is provided a computer-readable recording medium for storing a program for performing a method of establishing a knowledge database. The method includes: building up a hypothesis suitable for dealing with an assigned task; generating keywords used for searching a plurality of databases based on the hypothesis; collecting data from the databases through searching with reference to the keywords; and extracting knowledge for dealing with the assigned task from the collected data and systematizing the extracted knowledge to be storable in a knowledge database.

### BRIEF DESCRIPTION OF THE DRAWINGS

The above and other features of the present invention will become more apparent by describing in detail exemplary embodiments thereof with reference to the attached drawings in which:

FIG. 1 is a diagram illustrating an expert system;

FIG. 2 is a block diagram of a conventional method of establishing a knowledge database;

FIG. 3 is a flowchart of a method of establishing a knowledge database according to an exemplary embodiment of the present invention;

FIG. 4 is a diagram illustrating an example of the method of establishing a knowledge database of FIG. 3;

FIG. 5 is a block diagram of an agent;

FIG. 6 is a block diagram of a standard model of an agent platform;

FIG. 7 is a block diagram of an apparatus for establishing a knowledge database according to an exemplary embodiment of the present invention;

FIG. 8 is a block diagram of an example of the apparatus for establishing a knowledge database of FIG. 7; and

FIG. 9 is a block diagram of another example of the apparatus for establishing a knowledge database of FIG. 7.

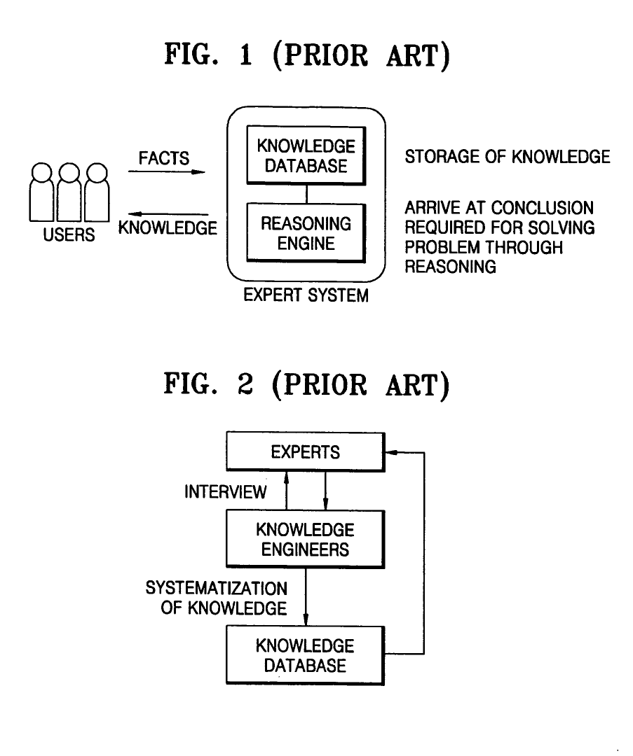

### DETAILED DESCRIPTION OF THE INVENTION

The present invention will now be described more fully with reference to the accompanying drawings in which exemplary embodiments of the invention are shown.

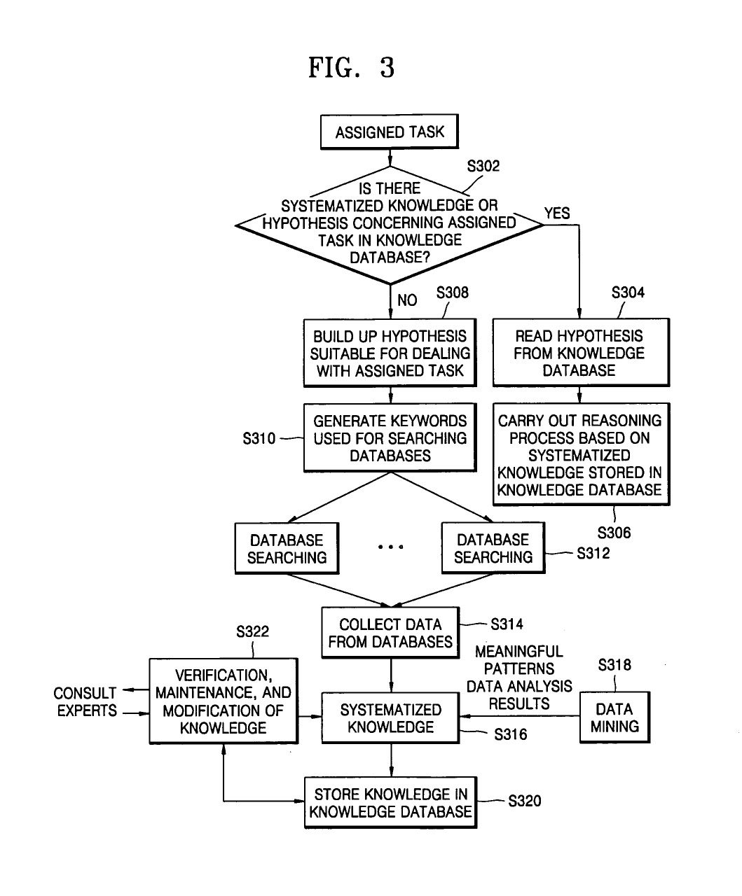

FIG. 3 is a flowchart of a method of establishing a knowledge database according to an exemplary embodiment of the present invention. Referring to FIG. 3, in operation S302, if a task is assigned, it is determined whether systematized knowledge or a hypothesis concerning the assigned task exists in a knowledge database. If systemized expertise or a hypothesis concerning the assigned task exists in the knowledge database, the hypothesis is read from the knowledge database in operation S304, and reasoning is carried out using the systematized knowledge in operation S306.

In operation S308, if no systematized knowledge or hypothesis concerning the assigned task exists in the knowledge database, a hypothesis is built up for the assigned task.

In operation S310, keywords necessary for database searching are generated based on the hypothesis built up in operation S308.

In operation S312, data are searched for in databases using the keywords generated in operation S310.

In operation S316, knowledge is extracted from the searched data, and the extracted knowledge is systematized so that it can be stored in the knowledge database. Specifically, in operation S316, meaningful patterns, such as association rules and sequential patterns, are extracted from the searched data using a data mining method, and then knowledge is extracted from the searched data using the meaningful patterns.

In operation S320, the systematized knowledge is stored in the knowledge database.

In operation S322, the knowledge extracted in operation S316 or knowledge previously stored in the knowledge database is verified, maintained, and modified by experts.

Data mining is a technique of exploring and acquiring useful information hidden in large quantities of data in the real world and is applied to various decision-making, prediction, and forecasting processes. Data mining helps businesses to discover meaningful patterns hidden in large quantities of data, to understand consumption patterns of their customers, to detect credit card theft and fraud and fraudulent insurance claims, and to predict changes in the financial market.

Data mining involves: selecting data to be analyzed from a database; appropriately processing, cleaning, and transforming the selected data; applying a data mining algorithm to the transformed data; and reprocessing results of applying a data mining algorithm to the transformed data and integrating the reprocessing results with existing knowledge. Knowledge obtained through data mining is used to create prediction or classification models, to discover relationships among records of the database, or to summarize the content of the database. Examples of knowledge obtained through data mining may include association rules, sequential patterns, classification rules, summarization rules, and clustering.

Association rules are rules of associating elements belonging to the same attribute with each other using an IF-THEN format. For example, if one of a plurality of attributes of data is ‘product’, and ‘diaper’ and ‘beer’ are elements belonging to the attribute ‘product’, the elements ‘diaper’ and ‘beer’ can be associated with each other by generating the following association rule: IF product=diaper, THEN product=beer, support=10%, confidence=70%. This association rule indicates that 10% of all customers bought diapers, and 70% of those who bought diapers also bought beer.

The apriori algorithm used in IBM's Intelligent Miner is one of the most widely used association algorithms.

Sequential patterns indicate sequences of events that occurred at different moments of time using the IF-THEN format. Sequential patterns are one type of temporal association rule while notion of time is added. For example, the following sequential pattern can be discovered from data concerning customers' consumption patterns: IF product=TV, THEN product=VCR. This sequential pattern indicates that customers who had bought TV bought a VCR.

The generalized sequential pattern (GSP) algorithm used in IBM's Intelligent Miner is one of the most widely used sequential pattern algorithms. The GSP algorithm is a variation of the apriori algorithm used in an association method. Data mining is disclosed in detail in Korean Patent Publication Nos. 2003-32096 (published on Apr. 26, 2003), 2001-31687(published on Apr. 16, 2001), and 2004-26178(published on Mar. 30, 2004).

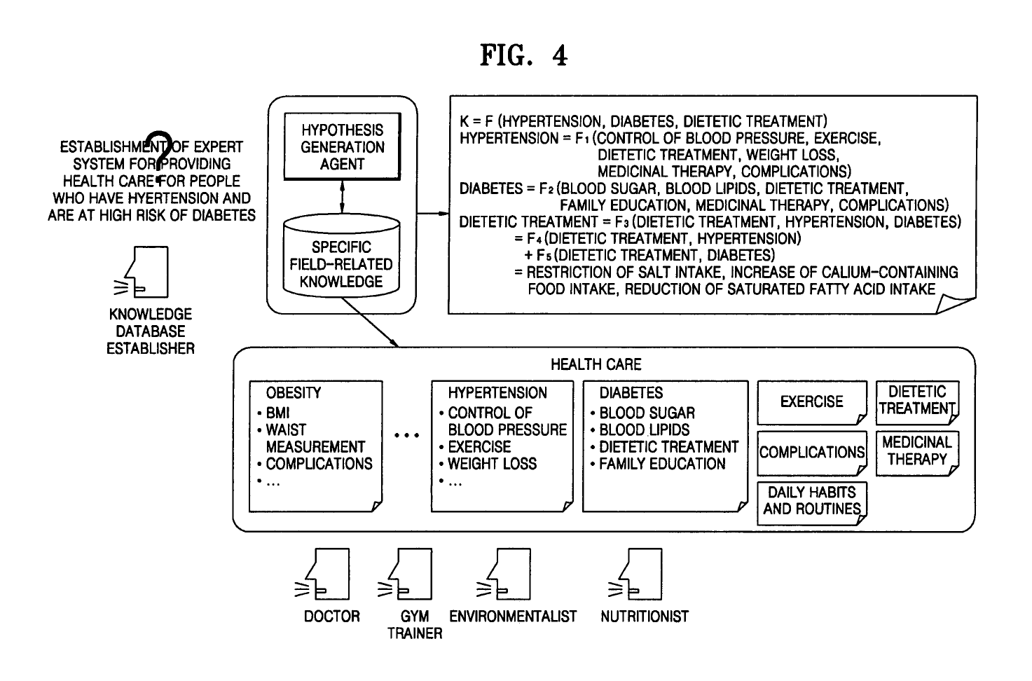

FIG. 4 is a block diagram of an example of the method of establishing a knowledge database of FIG. 3. Specifically, FIG. 4 illustrates an example of the establishment of an expert system for providing health care to people with hypertension.

Referring to FIGS. 3 and 4, in operation S308, if an assigned task is ‘health care for people who have hypertension and are at high risk of diabetes’, a hypothesis that “a dietetic treatment is required” is built up for dealing with the assigned task with reference to health care-related knowledge.

The health care-related knowledge is classified into obesity, hypertension, diabetes, exercise, complication, habit, dietetic treatment, and medicinal therapy categories.

In operation S310, keywords are generated based on the hypothesis built up in operation S308. For example, ‘blood pressure control’, ‘exercise’, ‘dietetic treatment’, ‘weight loss’, ‘medicinal therapy’, and ‘complications’ are generated as a set F1 of keywords for the hypertension category, ‘blood sugar’, ‘blood lipids’, ‘dietetic treatment’, ‘family education’, ‘medicinal therapy’, and ‘complications’ are generated as a set F2 of keywords for the diabetes category, and ‘dietetic treatment’, ‘hypertension’, and ‘diabetes’ are generated as a set F3 of keywords for the dietetic treatment category.

In operation S312, data is searched for in various databases, such as a health care-related database, a medical records database, a menu management database, a habit database, and an academic database.

In operation S316, knowledge for dealing with the assigned task is extracted from the searched data with reference to meaningful patterns extracted from the searched data in operation S318. Specifically, in operation S316, knowledge is primarily extracted from the searched data using a statistical method. In operation S318, meaningful patterns, such as association rules and sequential patterns, are extracted from the searched data. In operation S316, the knowledge primarily extracted from the searched data is systematized with reference to the extracted meaningful patterns, thereby obtaining the knowledge for dealing with the assigned task.

Examples of the knowledge for dealing with the assigned task may include ‘restriction of salt intake’, ‘increase of kalium-containing food intake’, and ‘reduction of saturated fatty acid intake’.

Thereafter, in operation S320, the hypothesis built up in operation S308 and the knowledge for dealing with the assigned task obtained in operation S316 are stored in a knowledge database.

Data stored in the knowledge database in operation S320 is as follows: IF ‘dietetic treatment for people who have hypertension and are also at high risk of diabetes’, THEN ‘restriction of salt intake’, ‘increase of kalium-containing food intake’, and ‘reduction of saturated fatty acid intake’.

In operation S322, the data stored in the knowledge database in operation S320 and knowledge previously stored in the knowledge database are verified, maintained, and modified. If there are mismatches among stores of information in the knowledge database, experts, such as doctors, sports trainers, environmentalists, or nutritionists, are consulted.

The method of establishing a knowledge database of FIG. 3 can automatically build up a hypothesis for dealing with an assigned task, generate keywords based on the hypothesis, search a plurality of databases for data using the keywords, extract knowledge for dealing with the assigned task from the searched data, and systematize the hypothesis and the extracted knowledge using a computer program, particularly, an agent. Thus, it is possible to establish a knowledge database without the aid of knowledge engineers. In addition, it is possible to prevent a knowledge acquisition bottleneck. Moreover, the knowledge database does not need to be perfect at an early stage after being established. Rather, the knowledge database can start off small and expand and evolve with use.

In the method of establishing a knowledge database of FIG. 3, knowledge is extracted from data, searched for from the databases using the keywords in a statistical manner, and then is systematized using meaningful patterns extracted from the searched data using a data mining method. Therefore, it is possible to establish a reliable knowledge database. In addition, since the data mining method enables the automatic analysis of data and the systematization of newly extracted knowledge, it is possible to overcome the restrictions of a conventional expert system and provide flexible problem-solving capabilities.

Knowledge and rules stored in the knowledge database can be verified, maintained, or fixed by experts in operation S322 of FIG. 3. Thus, it is possible to establish a more reliable knowledge database.

The operations included in the method of establishing a knowledge database of FIG. 3 are performed by agents. Agents are computer programs or devices that are capable of understanding intent and making decisions on their own based on the circumstances. Agents are suggested as interfaces between humans and computers. Search engines which automatically collect information from the Internet and establish databases on the collected information are one type of agent. An example of a search agent is disclosed in U.S. Pat. No. 5,781,703 (published on Jun. 4, 1998).

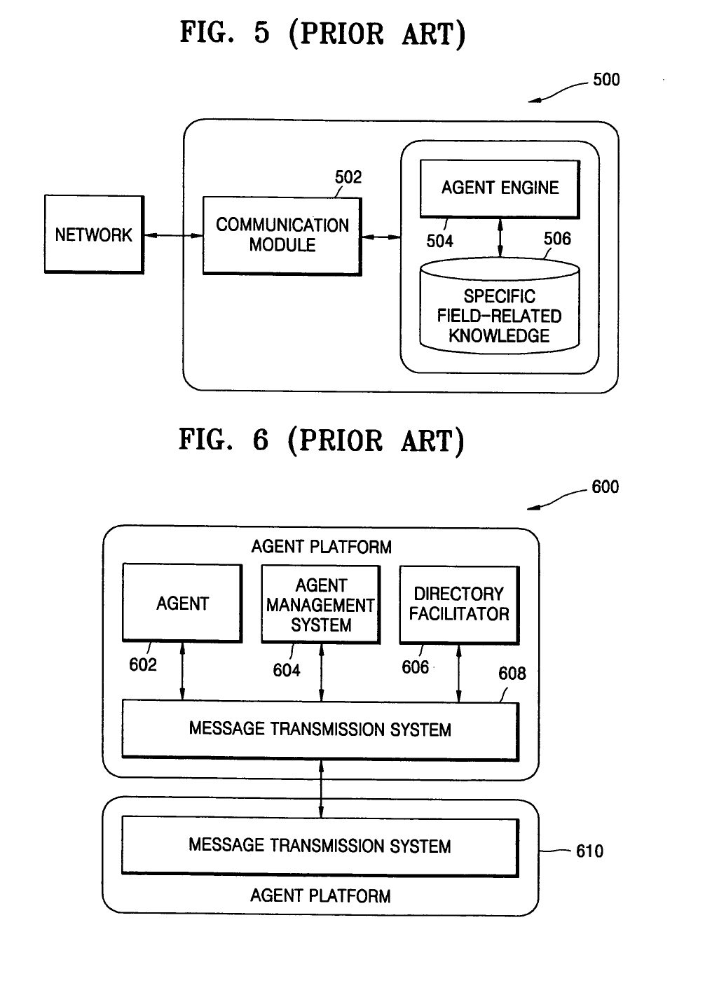

FIG. 5 is a block diagram of an agent 500. Referring to FIG. 5, the agent 500 includes a communication module 502, an agent engine 504, and a knowledge database 506. The communication module 502 communicates with other agents by transmitting messages to and receiving messages from them. The agent engine 504 has control and reasoning capabilities so that it can control the creation, operation, termination, etc. of the agent 500. Specific field-related knowledge is knowledge for dealing with tasks assigned in relation to a specific application field. The role of the agent 500 is characterized by the specific field-related knowledge. When the agent 500 is created, it attempts to share operations with other agents by disclosing its capabilities in relation to the specific field-related knowledge.

FIG. 6 is a block diagram of a standard model of an agent platform 600 suggested by the Foundation for Intelligent Physical Agents (FIPA). Referring to FIG. 6, the agent platform 600 includes an agent 602, an agent management system 604, a directory facilitator 606, and a message transmission system 608. Even though only one agent (602) is illustrated in FIG. 6, the agent platform 600 may include a plurality of agents.

The directory facilitator 606 stores the capabilities of the agent 602 and services provided by the agent 602 as ordered pairs. The ordered pairs are automatically maintained based on information input to the agent platform 600 when the agent 602 is registered with the agent platform 600.

The agent management system 604 manages the registration, operation, and termination of the agent 602.

The message transmission system 608 serves as an interface between the agent platform 600 and another agent platform 610 by transmitting information written or requested by the agent 602.

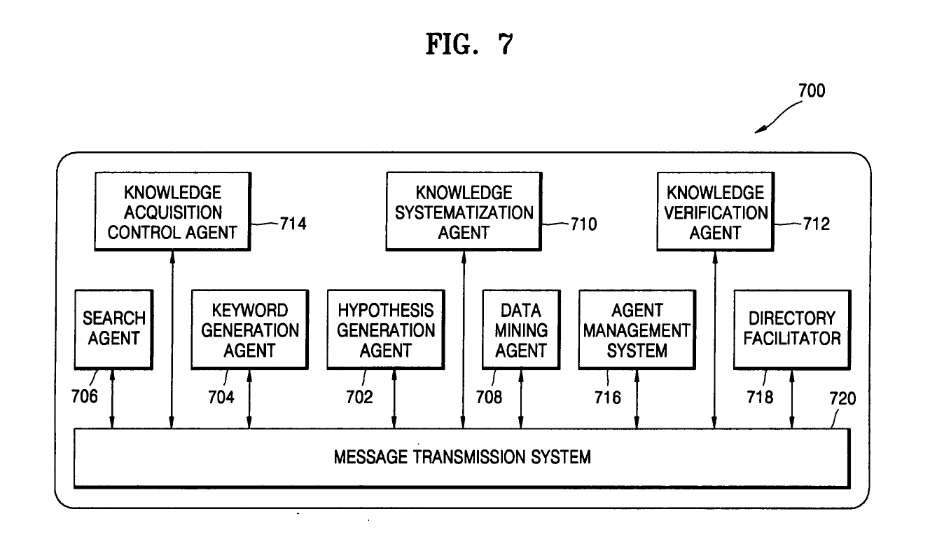

FIG. 7 is a block diagram of an apparatus 700 for establishing a knowledge database according to an exemplary embodiment of the present invention. Referring to FIG. 7, the apparatus 700 includes a hypothesis generation agent 702, a keyword generation agent 704, a search agent 706, a data mining agent 708, a knowledge systematization agent 710, a knowledge verification agent 712, a knowledge acquisition control agent 714, an agent management system 716, a directory facilitator 718, and a message transmission system 720.

The hypothesis generation agent 702 determines whether there is systematized knowledge or a hypothesis concerning an assigned task in a knowledge database, and builds up a hypothesis appropriate for dealing with the assigned task if there is no systematized knowledge or hypothesis concerning the assigned task in the knowledge database.

The keyword generation agent 704 generates keywords based on the hypothesis built up by the hypothesis generation agent 702 and used for searching a plurality of databases in the same field as the assigned task.

The search agent 706 searches the databases for necessary data using the keywords generated by the keyword generation agent 704.

The data mining agent 708 extracts meaningful patterns from the data searched for by the search agent 706, using a data mining method, by filtering and analyzing the searched data and interpreting the analysis results.

The knowledge systematization agent 710 extracts knowledge for dealing with the assigned task from the searched data using the extracted meaningful patterns and systematizes the extracted knowledge so that it can be stored in the knowledge database.

The knowledge verification agent 712 verifies the systematized knowledge stored in the knowledge database. In addition, the knowledge verification agent 712 updates, maintains, or modifies the systematized knowledge stored in the knowledge database by re-systematizing it. If there are mismatches or uncertainties in the systematized knowledge stored in the knowledge database, the knowledge verification agent 712 consults experts.

The knowledge acquisition control agent 714 controls the operations of agents that perform knowledge acquisition-related tasks, for example, the search agent 706, the keyword generation agent 704, the hypothesis generation agent 702, and the data mining agent 708.

The agent management system 716 manages the registration, operation, and termination of each of the search agent 706, the keyword generation agent 704, the hypothesis generation agent 702, and the data mining agent 708.

The directory facilitator 718 stores, as ordered pairs, the capabilities of and services provided by the search agent 706, the keyword generation agent 704, the hypothesis generation agent 702, and the data mining agent 708, and the directory facilitator 718 also manages the ordered pairs.

The message transmission system 720 serves as an interface between the agents of the apparatus 700 and other agent platforms, other knowledge databases, or other databases.

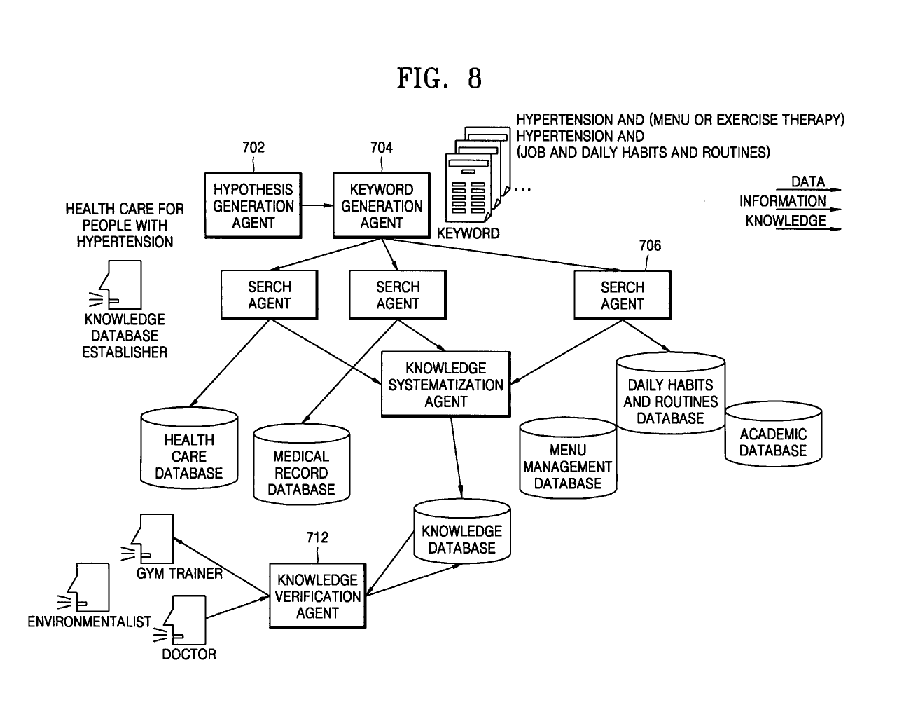

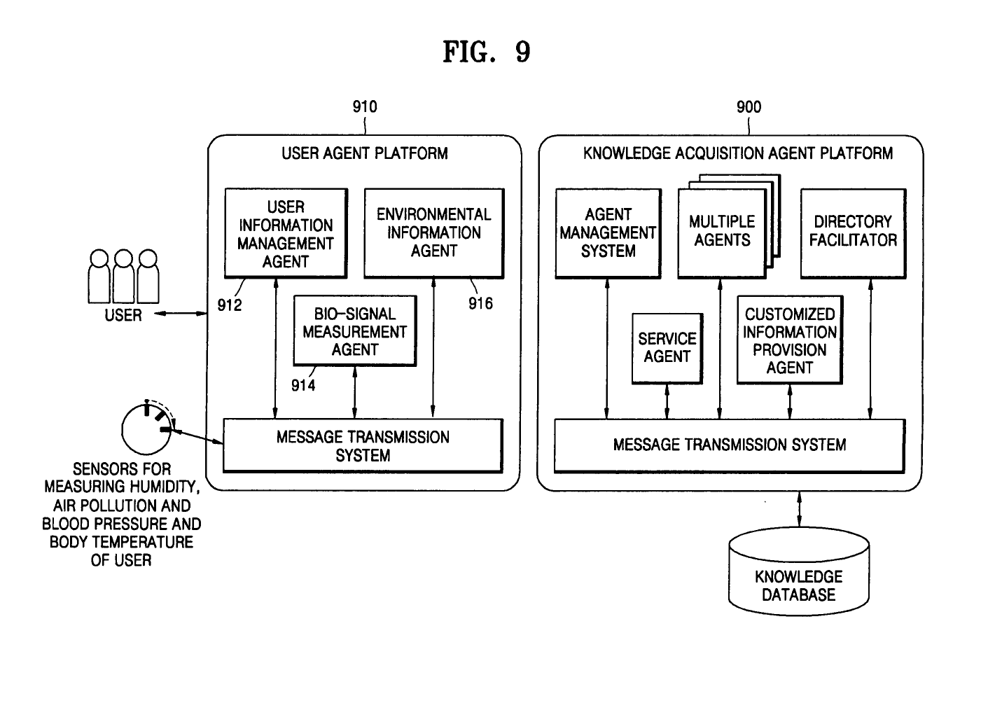

FIG. 8 is a block diagram illustrating an example of the apparatus for establishing a knowledge database of FIG. 7. Referring to FIG. 8, supposing that an assigned task is ‘health care for people with hypertension’, the hypothesis generation agent 702 determines whether there is systematized knowledge or a hypothesis concerning the assigned task in a knowledge database. If systematized knowledge or a hypothesis concerning the assigned task exists in the knowledge database, the hypothesis generation agent 702 reads the hypothesis from the knowledge database and carries out a reasoning process using the systematized knowledge stored in the knowledge database.

If there is no systematized knowledge or hypothesis concerning the assigned task in the knowledge database, the hypothesis generation agent 702 builds up a hypothesis appropriate for dealing with the assigned task, for example, ‘people who have hypertension and are obese need exercise therapy’.

The keyword generation agent 704 generates keywords for dealing with the assigned task, for example, ‘hypertension AND (diet OR exercise therapy)’ and ‘hypertension AND (job OR habits)’, based on the hypothesis built up by the hypothesis generation agent 702.

The search agent 706 searches a plurality of databases, such as a health care-related database, a medical records database, a diet management database, a habit database, and an academic database, for data using the keywords generated by the keyword generation agent 704. The searched data is provided to the knowledge systematization agent 710 and the data mining agent 708.

The knowledge systematization agent 710 extracts knowledge for dealing with the assigned task from the searched data using meaningful patterns extracted by the data mining agent 708.

For example, the extracted knowledge may be ‘walk for twenty minutes everyday’.

Thereafter, the knowledge systematization agent 710 systematizes the extracted knowledge so that it can be stored in the knowledge database. For example, the systematized knowledge may be as follows: IF ‘hypertension AND Obesity’, THEN ‘walk for twenty minutes everyday’.

The knowledge verification agent 712 determines whether the systematized knowledge conflicts or coincides with systematized knowledge previously stored in the knowledge database. If the systematized knowledge conflicts with the systematized knowledge previously stored in the knowledge database or if there are uncertainties in the knowledge database, the knowledge verification agent 712 consults experts, such as sports trainers, environmentalists, doctors, etc.

FIG. 9 is a block diagram of another example of the apparatus for establishing a knowledge database of FIG. 7, i.e., an apparatus 900 for establishing a knowledge database. Referring to FIG. 9, a user agent platform 910 includes a user information management agent 912, a bio-signal measurement agent 914, and an environmental information agent 916. The apparatus 900 cooperates with the user agent platform 910 to provide a user with stores of information regarding his or her physical condition or the environmental state of a place where he or she resides.

The environmental information agent 916 measures humidity and air pollution, and the bio-signal measurement agent 914 measures the blood pressure and body temperature of the user.

As described above, the method of establishing a knowledge database according to the present invention can reduce the time and cost required for establishing a knowledge database of an expert system by automatically updating, maintaining, or fixing the knowledge database without the aid of knowledge engineers. In addition, the method of establishing a knowledge database according to the present invention can enhance the quality and reliability of knowledge stored in the knowledge database.

The apparatus for establishing a knowledge database according to the present invention can provide more sophisticated knowledge for an assigned task by considering the assigned task from all angles using a plurality of agents and allowing a management agent that controls the operations of the agents to discover the correlations between the assigned task and its various aspects.

While the present invention has been described with reference to exemplary embodiments thereof, it will be apparent to those of skill in the art that various changes and modifications can be made to the described embodiments without departing from the spirit and scope of the present invention as defined in the appended claims.

What is claimed is:

1. A method of establishing a knowledge database, comprising:
building up a hypothesis suitable for dealing with an assigned task;
generating keywords used for searching a plurality of databases based on the hypothesis;
collecting data from the plurality of databases through searching with reference to the keywords; and
extracting knowledge for dealing with the assigned task from the collected data and systematizing the extracted knowledge to be storable in the knowledge database.

2. The method of claim 1 further comprising:
extracting meaningful patterns from the collected data using a data mining method,
wherein in the systematizing of the extracted knowledge, the extracted knowledge is re-systematized using the meaningful patterns extracted from the collected data.

3. The method of claim 2, wherein the meaningful patterns comprise association rules and sequential patterns.

4. The method of claim 1 further comprising storing the systematized knowledge in the knowledge database.

5. The method of claim 4 further comprising verifying, maintaining, or fixing the systematized knowledge stored in the knowledge database, and consulting experts if there are conflicts between the systematized knowledge stored in the knowledge database and other systematized knowledge previously stored in the knowledge database.

6. An apparatus for establishing a knowledge database, comprising:
a hypothesis generation agent, which builds up a hypothesis suitable for dealing with an assigned task;
a keyword generation agent, which generates keywords used for searching a plurality of databases based on the hypothesis;
a search agent, which collects data from the plurality of databases through searching with reference to the keywords;
a data mining agent, which extracts meaningful patterns from the collected data using a data mining method by filtering and analyzing the collected data and interpreting the analysis results;
a knowledge systematization agent, which extracts knowledge for dealing with the assigned task from the collected data using the extracted meaningful patterns and systematizes the extracted knowledge to be storable in the knowledge database; and
a knowledge acquisition control agent, which controls the operations of the hypothesis generation agent, the keyword generation agent, the search agent, the data mining agent, and the knowledge systematization agent when the hypothesis generation agent, the keyword generation agent, the search agent, the data mining agent, and the knowledge systematization agent deal with knowledge acquisition-related tasks.

7. The apparatus of claim 6 further comprising:
a knowledge verification agent, which verifies the knowledge systematized by the knowledge systematization agent or systematized knowledge previously stored in the knowledge database and updates, maintains, or fixes the knowledge database by re-systematizing the knowledge systematized by the knowledge systematization agent or the systematized knowledge previously stored in the knowledge database.

8. The apparatus of claim 7, wherein the knowledge verification agent consults experts if there are conflicts between the knowledge systematized by the knowledge systematization agent and the systematized knowledge previously stored in the knowledge database, or if there are uncertainties in the knowledge database.

9. A computer-readable recording medium for storing a program for performing a method of establishing a knowledge database, the method comprising:
building up a hypothesis suitable for dealing with an assigned task;
generating keywords used for searching a plurality of databases based on the hypothesis;
collecting data from the plurality of databases through searching with reference to the keywords; and
extracting knowledge for dealing with the assigned task from the collected data and systematizing the extracted knowledge to be storable in the knowledge database.

10. The computer-readable recording medium of claim 9, wherein the method further comprises:
extracting meaningful patterns from the collected data using a data mining method, wherein in the systematizing of the extracted knowledge, the extracted knowledge is re-systematized using the meaningful patterns extracted from the collected data.

11. The computer-readable recording medium of claim 9, wherein the method further comprises:
verifying, maintaining, or fixing the systematized knowledge stored in the knowledge database and consulting experts if there are conflicts between the systematized knowledge stored in the knowledge database and other systematized knowledge previously stored in the knowledge database.

12. An apparatus for establishing a knowledge database, comprising:
a hypothesis generation agent, which builds up a hypothesis suitable for dealing with an assigned task;
a keyword generation agent, which generates keywords used for searching a plurality of databases based on the hypothesis;
a search agent, which collects data from the plurality of databases through searching with reference to the keywords;
a knowledge systematization agent, which extracts knowledge for dealing with the assigned task from the collected data and systematizes the extracted knowledge to be storable in the knowledge database; and
a knowledge acquisition control agent, which controls the operations of the hypothesis generation agent, the keyword generation agent, the search agent, and the knowledge systematization agent when the hypothesis generation agent, the keyword generation agent, the search agent, the data mining agent, and the knowledge systematization agent deal with knowledge acquisition-related tasks.
